(19) United States
(12) Patent Application Publication
(10) Pub. No.: US 2025/0005992 A1
(43) Pub. Date: Jan. 2, 2025

(54) CARD READER FOR ATMS, CASH MACHINES, AND SIMILAR DEVICES

(71) Applicant: M.I.B. S.r.l., Milano (IT)

(72) Inventor: Giuseppe Ezio FUMANELLI, Melzo (IT)

(21) Appl. No.: 18/756,732

(22) Filed: Jun. 27, 2024

(30) Foreign Application Priority Data
Jun. 30, 2023 (IT) 102023000013719

(51) Int. Cl. G07F 7/08; G06K 19/073; G07F 19/00

(52) U.S. Cl. CPC G07F 7/088; G06K 19/07327; G06K 19/07336; G07F 19/21

(57) ABSTRACT

An electronic card reader (50) for ATMs, cash machines, or similar devices (100) is provided, the electronic card (50) comprising electronic information storage means (51) and information transmission means (54), the reader comprising: an access port, defining an access slot (11), through which electronic cards (50) can be inserted and extracted, an internal volume (10), adjacent to the access slot (11) designed to at least partially house the electronic card (50), reading means of the information storage means (51), designed to read the electronic information when the electronic card (50) is at least partially housed within the internal volume (10), electronic control means functionally connected to the reading means; optical control means, designed to verify the presence of foreign bodies within the internal volume (10), the control means being functionally connected to the control means and designed to determine if the foreign bodies in the internal volume consisted of the authorized type of electronic card (50).

### TECHNICAL FIELD OF THE INVENTION

This invention relates to an electronic card reader for ATMs, cash machines, and similar devices, featuring an access port, defining an access slot, through which electronic cards can be inserted and extracted, an internal volume, adjacent to the access slot and designed to at least partially house the electronic card, reading means of said information storage means, designed to read said electronic information on said electronic card at least partially housed inside said internal volume, electronic control means functionally connected to the reading means.

### DESCRIPTION OF PRIOR ART

Currently known are cash or value distributors, such as particularly ATMs or cash machines or systems designed to contain banknotes.

They comprise a container consisting of a safe capable of containing banknotes and values, and control and dispensing means designed to dispense or receive banknotes and values to and from an authorized user.

The dispensing of banknotes and values occurs after user recognition through electronic cards or similar devices.

These electronic cards generally include a magnetic strip and/or an electronic chip for the purpose of electronically storing and sharing information.

The latter, in turn, can be read through a reader in electrical contact with it and/or through an RFID reader, if the electronic card is equipped with the relevant antenna. The electronic card reader comprises, in turn, an access port through which the electronic cards can be inserted and extracted, and reading means for the magnetic strip and/or chip. This latter reading occurs through the contact reader and/or through an RFID reader.

The known technique described includes some significant drawbacks.

Specifically, in recent times, thefts and attempts to steal data stored in said electronic cards through illegal readers, also known as skimmers, have occurred.

These illegal readers are inserted by malicious individuals inside the card readers, also called card readers. Such illegal readers are very thin and do not interfere with the operation of the electronic card readers in ATMs, cash machines, and similar devices.

Additionally, the same illegal readers can send the data wirelessly, such as via Bluetooth® or WiFi®, outside the electronic card reader and the ATM or cash machine, potentially also at considerable distances using the web.

Malicious individuals can thus perform the theft undisturbed at a distance from the unsuspecting user using an ATM or cash machine having the illegal reader therein. Additionally, another drawback is caused by the fact that the user, or whoever is responsible, cannot detect the presence of the illegal reader.

### SUMMARY OF THE INVENTION

In this situation, the technical task underlying the present invention is to devise an electronic card reader for ATMs, cash machines, and similar devices capable of substantially overcoming at least part of the cited drawbacks.

Within the scope of this technical task, an important object of the invention is to achieve an electronic card reader for ATMs, cash machines, and similar devices that allows avoiding frauds involving the insertion of illegal readers inside these card readers.

The technical task and specified objects are achieved by an electronic card reader for ATMs, cash machines, or similar devices, wherein the electronic card comprises means for storing electronic information and means for transmitting said information; the reader comprising: an access port, defining an access slot, through which the electronic cards can be inserted and extracted; an internal volume, adjacent to the access slot, designed to at least partially house the electronic card; reading means of the information storage means, designed to read the electronic information on the electronic card at least partially housed in the internal volume; electronic control means functionally connected to the reading means; the reader comprising optical control means, designed to verify the presence of foreign bodies in the internal volume; the control means being functionally connected to the control means and designed to determine if the foreign bodies in the internal volume are constituted by consist of an authorized type of electronic card.

### BRIEF DESCRIPTION OF THE DRAWINGS

The characteristics and advantages of the invention are clarified by the following detailed description of preferred embodiments of the invention, with reference to the accompanying drawings, wherein:

FIG. 1 shows a schematic cross-section of an electronic card reader for ATMs, cash machines, or similar devices according to the invention;

FIG. 2 schematically shows an ATM, cash machine, or similar device including an electronic card reader according to the invention; and

FIG. 3 illustrates an electronic card for an electronic card reader according to the invention.

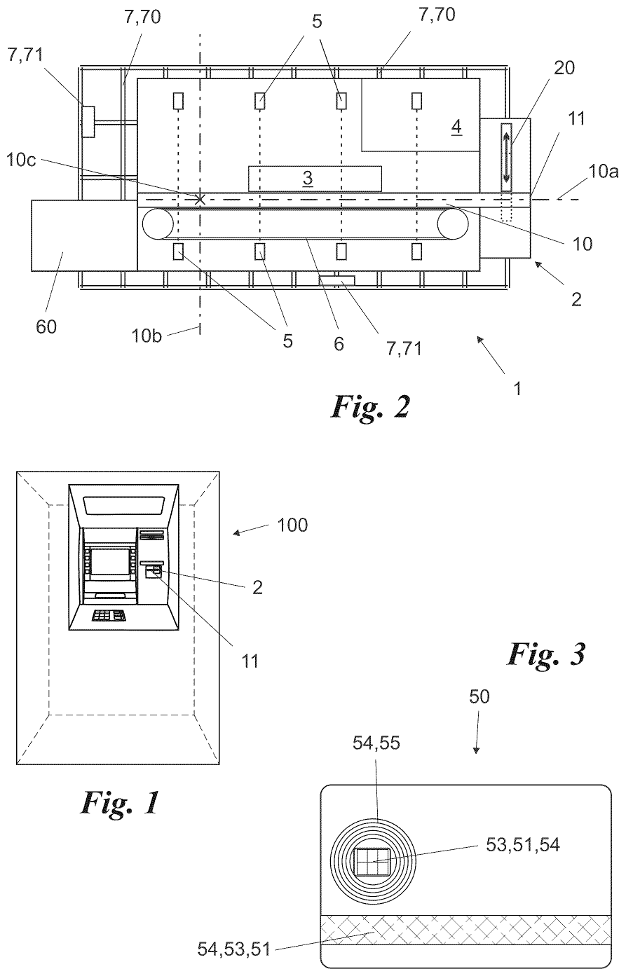

### DESCRIPTION OF PREFERRED EMBODIMENTS

In this document, measurements, values, shapes, and geometric references (such as perpendicularity and parallelism), when associated with words like “approximately” or similar terms such as “almost” or “substantially”, are to be understood as being within measurement errors or inaccuracies due to production and/or manufacturing errors and, in particular, within a slight deviation from the value, measurement, shape, or geometric reference to which it is associated. For example, such terms, if associated with a value, preferably indicate a deviation not exceeding 10% of the value itself.

Furthermore, when used, terms such as “first”, “second”, “upper”, “lower”, “main”, and “secondary” do not necessarily identify an order, priority of relation, or relative position, but may simply be used to more clearly distinguish different components from one another.

Unless otherwise specified, as results from the following discussions, it is considered that terms like “processing”, “computing”, “determining”, “calculating”, or similar, refer to the action and/or processes of a computer or similar electronic computing device that manipulates and/or transforms data represented as physical quantities, such as electronic magnitudes of registers of a computer system and/or memories into other data similarly represented as physical quantities within computer systems, registers, or other storage, transmission, or information display devices.

The measurements and data reported herein are to be considered, unless otherwise indicated, as performed in International Standard Atmosphere ICAO (ISO 2533:1975).

Referring to the Figures, the electronic card reader for ATMs, cash machines, or similar devices according to the invention is globally denoted by the number 1. It is designed to be placed inside an ATM, cash machine, or similar device 100, and is also commonly referred to as a card reader.

The invention also defines an ATM, cash machine, or similar device 100 including the electronic card reader 1.

The card reader 1 is designed to read electronic cards 50.

The electronic cards 50 are known per se and include information storage means 51 of electronic information, such as a magnetic strip 52 and/or an electronic chip 53 or other. The electronic cards 50 also include information transmission means 54 such as the external surface of the electronic chip 53 and/or the external surface of the magnetic strip 52 and/or also an RFID antenna 55, preferably of the passive type and preferably connected to the electronic chip 53 or similar. Structurally, the cards 50 are preferably substantially flat, with a height preferably less than a millimeter and with base plane dimensions not exceeding a centimeter.

The electronic cards 50 also preferably have standardized dimensions and positions for said transmission means 54.

The card reader 1 generally comprises an access port 2, defining an access slot 11, towards the outside of the reader 1 and the ATM or cash machine 100, through which the electronic cards 50 can be inserted and extracted, an internal volume 10, adjacent to the access slot 11, designed to at least partially house an electronic card 50, reading means 3 of the information storage means 51, known per se, and electronic control means 4, functionally connected to the reading means 3 and other elements.

More specifically, the access slot 11 is substantially the portion facing outward and bidimensional of the internal volume 10. It extends along a plane and mainly in a transverse direction 10c. It is also preferably substantially counter-shaped to the electronic card 1 so that it can be inserted in only one position.

The internal volume 10 extends mainly along a longitudinal direction 10a, not parallel and preferably perpendicular to the transverse direction 10c. The vertical direction 10b completes the three axes in space and is perpendicular to the longitudinal direction 10a and the transverse direction 10c.

Preferably, the internal volume 10 is designed to entirely house the electronic card 50, which thus disappears from the user's view during use.

The reader 1 also preferably comprises means 6 for moving the electronic card 50 when it is at least partially housed inside the internal volume 10. These means consist, for example, of a high-friction conveyor belt, rollers, wheels, or similar, and are known per se. Preferably, the movement means 6 are designed to transfer the card 50 into a container 60 arranged, with respect to the longitudinal direction 1a, in a position opposite to the access port 2, designed to contain the cards 50 to be retained or similar elements.

The access port 2 also preferably comprises a shutter 20 designed to regulate said access slot 11 by preventing the introduction of the electronic card 50 at different times. It preferably consists of a substantially flat element that can be moved by appropriate electromechanical means, e.g., a solenoid connected to the control means 4, and preferably in the vertical direction 10b, so as to interfere or not with the first part of the internal volume 10, near the access slot 11.

The reading means 3 can comprise at least one magnetic strip reader 52, and/or at least one electronic chip reader 53, preferably mobile in the vertical direction 1c so as to contact said chip 53 or to clear space, an RFID passive antenna reader 55, or other devices.

The control means 4 consist, for example, of one or more computers, microcomputers, electronic boards, PLCs, or similar known devices, and can also be shared with the control means of the ATM or cash machine 100 or connected to the latter. They can thus be structurally present inside the reader 1 or outside of it and connected to the reader 1 itself. In particular, preferably, the control means 5 described below have their own control electronics that can interface with the electronics of the reader 1 and/or the ATM, cash machine, or similar.

The reader 1, advantageously and preferably, comprises optical control means 5, designed to verify the presence of foreign bodies in the internal volume 10. They are preferably functionally connected to the control means 4. The latter are designed to determine if the foreign bodies in the internal volume 3 are made with shapes different in size or length from the authorized type of electronic cards 50 or other elements, such as illegal readers and similar.

Preferably, the optical control means 5 are infrared photoelectric sensors, ultrasonic sensors, or alternatively, cameras or other control means. Even more preferably, they are reflection-type optical means, such as those used to measure distances, preferably also using infrared.

Preferably, a plurality of control means 5 is present, designed to verify the presence and position, or a plurality of positions, of the electronic card 50 inside the internal volume 10. They can also be designed to detect the direction of movement and/or the displacement speed of the electronic card 50.

Said control means 4, in cooperation with the control means 5, can also include, or be connected to, a timer designed to measure the residence time of the electronic card or other foreign bodies 50 in the internal volume 10, and detect any tampering. The reader 1, advantageously and preferably, comprises obstacle means 7 designed to prevent wireless electronic communications, such as Bluetooth® or WiFi®, from being transmitted by an element present inside the internal volume 10 to the outside of the reader 1.

They preferably comprise at least a partial Faraday cage 70, preferably arranged at least around the internal volume 10 or around the entire reader 1.

The Faraday cage 70 is known per se and is preferably made of continuous metallic surfaces designed to enclose and/or shield radio signals with materials and dimensions known to the technician in the field of electromagnetic fields.

The obstacle means 7 preferably include a jammer 71, also known as a jamming device or cell phone jammer. The jammer 71, known per se, is designed to prevent the correct functioning of transmissions. In the present case, given that the internal volume 10 or the reader 1 volume is very small, the jammer can have very low power and not cause disturbances outside. Additionally, preferably, the jammer 71 is arranged inside the Faraday cage 70, so as not to disturb any external telephone communications which are usually on different frequencies, thus improving the isolation of the reader 1.

The ATM or cash machine 100 including the card reader 1, preferably also includes per se known elements, such as the screen, the internal safe, the banknote dispenser and/or acceptor, the electronic control means, keyboards, and other elements, alarm means, and similar.

The operation of the card reader 1 and the ATM or cash machine 100 previously described in structural terms is as follows.

The user intending to withdraw or deposit banknotes inserts his/her electronic card 50 into the slot 11.

The control means 4, if no irregularities are detected, open the shutter 20 and allow the insertion of said electronic card 50. The latter is dragged by the movement means 6 inside the internal volume 10, and preferably, the shutter 20 closes. The electronic card 50 is then retracted in the longitudinal direction 10a and brought back into contact with the shutter 20.

In this position, the transmission means 53, on the electronic card 50 can be connected to the reading means 3 which can read the information stored in the storage means 51.

In this way, the identity of the user can be verified, possibly together with the request for a PIN, password, SMS, or similar, validating the withdrawal or deposit operation. After the operation is completed, the shutter 20 is opened again, and the electronic card 50 is transported by the movement means 6 to the outside of the access slot 11.

The control means 4 guide the entire operation.

If the control means 4 indicate that the internal volume 10 is not free and the control means 5 detect the presence of a foreign element, such as an illegal reader or other foreign body, an alarm is activated.

Such alarm can also be activated if the timer indicates residence times different from those expected within the reader.

Additionally, preferably, in case of an alarm, the shutter 20 remains closed, and the card reader is turned off, as is the ATM or cash machine 100, making the card reader 1 unusable. In such a case, the card reader 1 can be switched of and its power supply can be interrupted until verification by an authorized operator. In such a case, any false reader can no longer receive electrical power from the reader.

In this sense, the control means 4 are designed to verify that the electronic card is authorized, i.e., that the body inside the internal volume 10 is indeed an appropriate electronic card and if said card is being used properly.

Additionally, in such a case, the movement means 6 can transfer the electronic card 50 into the container 60 for further investigation or similar.

In any case, if present, the obstacle means 7 prevent the false reader from correctly communicating wirelessly with the outside.

The card reader 1 and the ATM or cash machine 100 according to the invention achieve significant advantages.

In fact, it allows avoiding frauds involving the insertion of an illegal reader inside the card reader.

It is also simple and economical.

This invention is susceptible to variations within the scope of the inventive concept defined by the claims.

1. An electronic card reader for ATMs, cash machines, or similar devices,
said electronic card comprising means for storing electronic information and means for transmitting said information,
said reader comprising:
an access port, defining an access slot, through which said electronic cards can be inserted and extracted,
an internal volume, adjacent to said access slot designed to at least partially house said electronic card,
reading means of said information storage means, designed to read said electronic information on said electronic card at least partially housed inside said internal volume,
electronic control means functionally connected to said reading means,
said reader comprising optical control means, designed to verify the presence of foreign bodies inside said internal volume,
said control means being functionally connected to said control means and designed to determine if said foreign bodies inside said internal volume consist of said authorized type of electronic card.

2. Reader according to claim 1, wherein said internal volume is designed to entirely house said electronic card, and wherein said reader comprises movement means for moving said electronic card when at least partially housed within said internal volume.

3. Reader according to claim 1, wherein said optical control means are infrared photoelectric sensors.

4. Reader according to claim 1, wherein said access port extends predominantly in a transverse direction, said internal volume extends predominantly in a longitudinal direction, not parallel and preferably perpendicular to said transverse direction, wherein said electronic card can be moved within said internal volume exclusively along said longitudinal direction, and wherein a plurality of said control means is present, designed to verify the presence and position of said electronic card within said internal volume.

5. Reader according to claim 1, wherein said access port comprises a shutter designed to obstruct said access slot, preventing the introduction of said electronic card.

6. Reader according to claim 1, comprising obstacle means designed to prevent wireless electronic communications from being transmitted by an element present within said internal volume to the outside of said reader.

7. Reader according to the previous claim, wherein said obstacle means comprise a Faraday cage.

8. Reader according to claim 6, wherein said obstacle means comprise at least one jammer.

9. Reader according to claim 7, wherein said jammer operates inside said Faraday cage.

10. ATM, cash machine, or similar device comprising an electronic card reader according to claim 7.
